(19) United States
(12) Patent Application Publication
(10) Pub. No.: US 2005/0271860 A1
(43) Pub. Date: Dec. 8, 2005

(54) Use of a single-sided self-adhesive tape as venting tape with an air permeability of more than 30 cm³/(cm² *s)

(75) Inventors: Torben Quednau, Hamburg (DE); Frank Kolmorgen, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa aktiengesellschaft, Hamburg (DE)

(21) Appl. No.: 11/120,545

(22) Filed: May 3, 2005

(30) Foreign Application Priority Data
Jun. 4, 2004 (DE) 10 2004 027 557.2

(51) Int. Cl. B32B 3/10

(52) U.S. Cl. 428/137

(57) ABSTRACT

Use of a single-sided self-adhesive tape as a venting tape where the adhesive tape is adhered across an aperture in a closed space which has a higher air pressure than the surrounding space, especially in connection with the foam-in-place filling of the sidewalls of white goods such as refrigerators, where
the single-sided self-adhesive tape has a backing to one side of which a hotmelt adhesive has been applied, and has an air permeability on the backing side of more than 30 cm³/(cm²*s),
the adhesive tape is perforated with hot needles, preferably located on a needle roll, the number of holes is at least 5/cm².

The present invention relates to the use of a single-sided self-adhesive tape as venting tape with an air permeability of more than 30 cm³/(cm²*s) and to its use as a venting tape where the adhesive tape is adhered across an aperture in a closed space which has a higher air pressure than the surrounding space, particularly in connection with the foam in-place filling of the sidewalls of white goods such as refrigerators.

The foam-in-place filling of the sidewalls of white goods is normally accomplished by introducing the liquid polyurethane into the cavity of the sidewall through an aperture. The polyurethane then foams so as to fill out the cavity.

In order to prevent the polyurethane or polyurethane foam exiting through the fill aperture or assembly apertures, these apertures are sealed with an adhesive tape.

The problem which arises in this process is that foaming within the cavity produces an excess pressure which must be brought down while the fill aperture is sealed with the adhesive tape.

For this reason the adhesive tape employed comprises tapes which have a certain air permeability.

To date, however, it has not been possible to guarantee the air permeability values called for by the white goods manufacturers for the adhesive tapes.

Perforated adhesive tapes are known from DE 102 52 516 A1. That patent describes a paint-compatible self-adhesive article intended for mechanical protection of painted, externally mounted plastic parts of cars and having a film-like backing material whose outside is laminated with a textile layer of knit product and whose inside is rendered tacky by application of a self-adhesive composition.

In one preferred embodiment, and specifically when used on painted plastic parts with a high residual solvent content in the paint, as a result for instance of low drying temperatures, the backing material may be perforated for the purpose of improved gas permeability.

DE 197 55 436 A1 disclosed a method of at least partially directly coating a stretchable backing material with a pressure-sensitive adhesive.

According to that method the backing material is guided by means of a transporting apparatus against a coating apparatus in such a way that by means of the coating apparatus the pressure-sensitive adhesive is applied to the backing material, the transporting apparatus having attachment or holding devices. These devices apply the forces needed to supply the material to and separate it from the coating unit, in a manner such that the properties of the backing are not altered in the course of coating.

In one embodiment, described as being advantageous, the holding device is a needle roll.

Needle rolls for perforating, embossing, transporting and opening drums or the like are widespread and commercially available for example from tambula, Bebra or from Burckhardt, Basle.

It is an object of the present invention to provide a venting tape, particularly in connection with the foam-in-place filling of the sidewalls of white goods such as refrigerators, which is capable of reproducibly guaranteeing a specified air permeability on the backing side and on the adhesive side.

This object is achieved through the use of a single-sided self-adhesive tape as described hereinbelow.

The invention accordingly provides for the use of a single-sided self-adhesive tape as a venting tape where the adhesive tape is adhered across an aperture in a closed space which has a higher air pressure than the surrounding space, especially in connection with the foam-in-place filling of the sidewalls of white goods such as refrigerators, where

the single-sided self-adhesive tape has a backing to one side of which a hotmelt adhesive has been applied, and has an air permeability on the backing side of more than 30 cm³/(cm²*s),

the adhesive tape is perforated with hot needles, preferably located on a needle roll,

the number of holes is at least 5/cm².

In a first preferred embodiment the adhesive tape is between 150 and 500 μm thick, in particular between 200 and 350 μm thick.

The breaking elongation of the adhesive tape according to one advantageous development is between 10% and 50%, the ultimate tensile strength is between 20 and 40 N/cm and the bond strength to steel is more than 1 N/cm, in particular more than 2.0 N/cm.

With further preference the adhesive tape has an air permeability on the backing side of more than 40 cm³/(cm²*s), in particular of more than 50 cm³/(cm²*s).

The air permeability on the adhesive side ought to be more than 50 cm³/(cm²*s), preferably more than 60 cm³/(cm²*s), more preferably more than 75 cm³/(cm²*s).

The coatweight (i.e. amount of adhesive applied per unit area) according to one preferred embodiment is between 40 and 60 g/m².

As backing material for the adhesive tape it is possible to use all known textile backings, such as wovens, knits or nonwoven webs; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics of this kind are disclosed in EP 0 071 212 B1. Spacer fabrics are matlike layer structures comprising a cover layer of a fiber or filament web, an underlayer and individual retaining fibers or bundles of such fibers between these layers, said fibers being distributed over the area of the layer structure, being needled through the particle layer, and joining the cover layer and the underlayer to one another. As an additional, though not mandatory, feature, the retaining fibers in accordance with EP 0 071 212 B1 comprise inert mineral particles, such as sand, gravel or the like, for example.

The holding fibers needled through the particle layer hold the cover layer and the underlayer at a distance from one another and are joined to the cover layer and the underlayer.

Spacer wovens or spacer knits are described, inter alia, in two articles, namely
an article from the journal kettenwirk-praxis 3/93, pages 59 to 63,
“Raschelgewirkte Abstandsgewirke” [Raschel-knitted spacer knits] and
an article from the journal kettenwirk-praxis 1/94, pages 73 to 76,
“Raschelgewirkte Abstandsgewirke”,
   the content of said articles being included here by reference and being part of this disclosure and invention.

Suitable nonwovens include, in particular, consolidated staple fiber webs, but also filament webs, meltblown webs, and spunbonded webs, which generally require additional consolidation. Possible consolidation methods for webs are mechanical, thermal, and chemical consolidation. Whereas with mechanical consolidations the fibers are held together purely mechanically, usually by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to fiber nodal points, so that a stable, three-dimensional network is formed while retaining the loose, open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained, inter alia, from the companies Naue Fasertechnik and Techtex GmbH. A Malifleece is characterized in that a cross-laid web is consolidated by the formation of loops from fibers of the web.

The backing used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced, inter alia, for many years, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of double-sided needle punching.

Finally, stitchbonded webs are also suitable as an intermediate for forming a cover of the invention and an adhesive tape of the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is mechanically preconsolidated in the first step or is a wet-laid web laid hydrodynamically, in which between 2% and 50% of the web fibers are fusible fibers, in particular between 5% and 40% of the fibers of the web.

A web of this kind is characterized in that the fibers are laid wet or, for example, a staple fiber web is preconsolidated by the formation of loops from fibers of the web or by needling, stitching or air-jet and/or water jet treatment.

In a second step, thermofixing takes place, with the strength of the web being increased again by the (partial) melting of the fusible fibers.

Starting materials envisaged for the textile backing include, in particular, polyester, polypropylene, viscose or cotton fibers. The present invention is, however, not restricted to said materials; rather it is possible to use a large number of other fibers to produce the web, as is evident to the skilled worker without any need for inventive activity.

Suitable backings also include those composed of paper, of a laminate or of a film (for example PP, PE, PET, PA, PU).

In a further preferred embodiment the backing material used is a nonwoven.

The adhesive tapes of the invention may comprise a hotmelt adhesive based on natural rubber or acrylates.

An adhesive which has proven to be particularly advantageous is one based on acrylate hotmelt and having a K value of at least 20, in particular more than 30, obtainable by concentrating a solution of such an adhesive to give a system which can be processed as a hotmelt.

Concentration may take place in appropriately equipped tanks or extruders; particularly in the case of accompanying devolatilization, a devolatilizing extruder is preferred.

An adhesive of this kind is set out in DE 43 13 008 A1, whose content is hereby referenced and is part of this disclosure and invention. In an intermediate step, the solvent is removed completely from the acrylate compositions prepared in this way. In addition, further volatile constituents are removed. After coating from the melt, these compositions contain only small fractions of volatile constituents. Accordingly, it is possible to adopt all of the monomers/formulas claimed in the above-cited patent. A further advantage of the compositions described in the patent is that they have a high K value and thus a high molecular weight. The skilled worker is aware that systems with relatively high molecular weights may be crosslinked more efficiently. Accordingly, there is a corresponding reduction in the fraction of volatile constituents.

The solution of the composition may contain from 5 to 80% by weight, in particular from 30 to 70% by weight, of solvent.

It is preferred to use commercially customary solvents, especially low-boiling hydrocarbons, ketones, alcohols and/or esters.

Preference is further given to using single-screw, twin-screw or multiscrew extruders having one or, in particular, two or more devolatilizing units.

The adhesive based on acrylate hotmelt may contain copolymerized benzoin derivatives, such as benzoin acrylate or benzoin methacrylate, for example, acrylates or methacrylates. Benzoin derivatives of this kind are described in EP 0 578 151 A1. The adhesive based on acrylate hotmelt may alternatively be chemically crosslinked.

In one particularly preferred embodiment, self-adhesive compositions used comprise copolymers of (meth)acrylic acid and esters thereof having from 1 to 25 carbon atoms, maleic, fumaric and/or itaconic acid and/or their esters, substituted (meth)acrylamides, maleic anhydride, and other vinyl compounds, such as vinyl esters, especially vinyl acetate, vinyl alcohols and/or vinyl ethers.

The residual solvent content should be below 1% by weight.

One adhesive indicated as particularly suitable is a low molecular mass, pressure sensitive acrylate hotmelt adhesive, such as that carried under the designation acResin UV or Acronal®, especially Acronal DS 3458, by BASF. This low-K adhesive acquires its application-oriented properties as a result of a final, radiation-chemically initiated crosslinking process.

Additionally it is possible to use a hotmelt adhesive composed from the group of the natural rubbers or synthetic rubbers or composed of any desired blend of natural rubbers and/or synthetic rubbers, it being possible to select the natural rubber or rubbers in principle from all available grades, such as, for example, crepe, RSS, ADS, TSR or CV grades, depending on the required purity and viscosity level, and to select the synthetic rubber or synthetic rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate (EVA) copolymers and polyurethanes and/or blends thereof.

With further preference it is possible to add thermoplastic elastomers to the rubbers, in order to improve the processing properties, with a weight fraction of from 10% to 50% by weight, based on the total elastomer fraction.

As representatives mention may be made at this point in particular of the especially compatible styrene-isoprene-styrene (SIS) and styrene-butadiene-styrene (SBS) products.

The adhesive tape is perforated using hot needles, located preferably on a needle roll, with a density of at least 5/cm2. The number of holes per cm2 is preferably more than 10 and more preferably more than 15.

The diameter of the needles and hence the diameter of the holes is between 0.5 and 1.5 mm, in particular between 0.9 and 1.00 mm.

The single-sided self-adhesive tape of the invention is outstandingly suitable for use as a venting tape where the adhesive tape is adhered across an aperture in a closed space which has a higher air pressure than the surrounding space, in particular in connection with the foam-in-place filling of the sidewalls of white goods such as refrigerators.

The adhesive tape is composed of a backing to one side of which a hotmelt adhesive has been applied.

If this adhesive tape is penetrated by hot needles, viz. needles having a temperature of preferably 100° C. and more preferably having a temperature of from 170° C. to 400° C., not only the backing material but also the adhesive in the direct vicinity of the needles are melted. Both materials are displaced simultaneously by the needles, so forming holes which pass right through the adhesive tape.

As the needles are extracted a cooling process begins in the marginal region of the holes, so that the backing material and in particular the hotmelt adhesive become solid.

In this way, holes are produced which are permanent, i.e. do not close up over time as a result in particular of the adhesive running back and sealing the hole.

This effect is observable with the existing adhesive tapes, so that they cannot be stored for any prolonged period. Moreover, immediately after the adhesive tape has been produced, the holes begin to shrink as a result of the slow runback of the adhesive, which gradually produces a sharp reduction in the air permeability.

At the present time, therefore, it is not possible to guarantee a particular air permeability of the adhesive tape for a prolonged period of time.

These problems have been solved in accordance with the invention. Through the use of a hotmelt adhesive there is no change in the adhesive at the usual (room) temperatures. The diameter of the holes remains constant—as a function of the diameter of the needles—and so produces a consistent air permeability in the adhesive tape.

### Test Methods

### Bond Strength

The peel strength (bond strength) was tested in a method based on PSTC-1. A strip of the pressure-sensitive adhesive tape 2 cm wide is adhered to the test substrate—for example, a ground steel plate or a PET plate—by rolling over the tape back and forth five times using a 5 kg roller. The plate is clamped in and the self-adhesive strip is peeled via its free end at a speed of 300 mm/min and at a peel angle of 180° on a tensile testing machine, the force required to achieve this being measured. The results are recorded in N/cm and are averaged over three measurements. All measurements were conducted at room temperature.

### Tensile Elongation Behavior/Breaking Elongation

The tensile elongation behavior of the wound film is determined on type-2 test specimens (rectangular test strips 150 mm long and where possible 15 mm wide) in accordance with DIN EN ISO 527-3/2/300 at a test speed of 300 mm/min, a clamped length of 100 mm and a pretensioning force of 0.3 N/cm. In the case of specimens with rough cut edges, the edges should be tidied up with a sharp blade prior to the tensile test. For determining the force or strain at 1% elongation, in deviation from the above procedure, measurement takes place with a test speed of 10 mm/min and a pretensioning force setting of 0.5 N/cm on a model Z 010 tensile testing machine (manufactured by Zwick). The testing machine is reported because the 1% value can be influenced somewhat by the evaluation program. The tensile elongation behavior, unless indicated otherwise, is tested in machine direction (MD, running direction). The force is expressed in N/strip width and the strain in N/strip cross-section, the breaking elongation in %. The test results, particularly the breaking elongation (elongation at break), should be statistically underpinned by means of a sufficient number of measurements.

### Air Permeability

The air permeability is tested using GURLEY orifice plates.

The air permeability is indicated by the volume of air which passes through a defined area per unit time.

The following equipment is used:

Densometer (W. & L. E. Gurley, Troy, N.Y., USA)

GURLEY orifice plate A (large): open area=1.0 sq. inch

GURLEY orifice plate B (small): open area=0.25 sq. inch

GURLEY orifice plate C (very small): open area=0.1 sq. inch

stopwatch

The inner cylinder of the Densometer is raised until it reaches the mounting spring, at which point it is fixed. Then the sample under analysis is adhered without tension to the appropriate orifice plate, which is inserted into the Densometer and screwed tight. The internal cylinder is then detached from the mounting spring, slowly lowered to the start mark and then released.

The drop time is measured using the stopwatch, as follows:

for orifice plates A and B, from the 100 cm3 to the 300 cm3 mark (air volume=200 cm);

for orifice plate C, from the 100 cm3 to the 150 cm3 mark (air volume=50 CM).

Test Result Using GURLEY Orifice Plates

Orifice plate A (large):

$$L = \frac{200 {cm}^{3}}{6.45 {cm}^{2} * t}$$

Orifice plate B (small):

$$L = \frac{200 {cm}^{3}}{1.61 {cm}^{2} * t}$$

Orifice plate C (very small):

$$L = \frac{200 {cm}^{3}}{0.645 {cm}^{2} * t}$$

Orifice plate description:

| GURLEY orifice plate | Open area in cm² | labeled “a” in FIG. 3 |
|---|---|---|
| A (large) | 6.45 | (=1.0 sq. inch) |
| B (small) | 1.61 | (=0.25 sq. inch) |
| C (very small) | 0.645 | (=0.1 sq. inch) |

### BRIEF DESCRIPTION OF THE DRAWINGS

One particularly advantageous version of the strip of the invention is illustrated with reference to the figures described below, without wishing thereby to restrict the invention unnecessarily.

FIG. 1 shows a strip of an adhesive tape of the invention, looking at the backing,

FIG. 2 shows the strip of adhesive tape of the invention according to FIG. 1 in a side section; and

FIG. 3 shows a Gurley orifice plate.

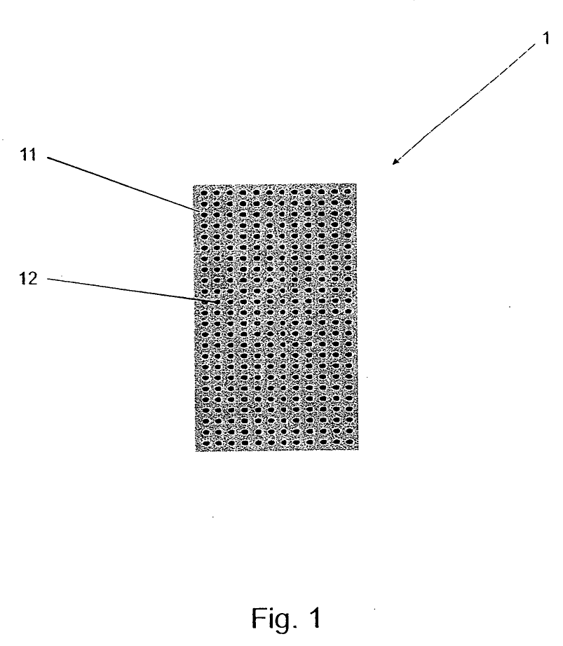

FIG. 1 shows a strip 1 of an adhesive tape of the invention, looking at the backing 11.

The strip 1 has a nonwoven backing 11 which is provided on its underside with an adhesive coating 13.

A multiplicity of holes 12 have been needled through the backing 11, specifically 14 per square meter.

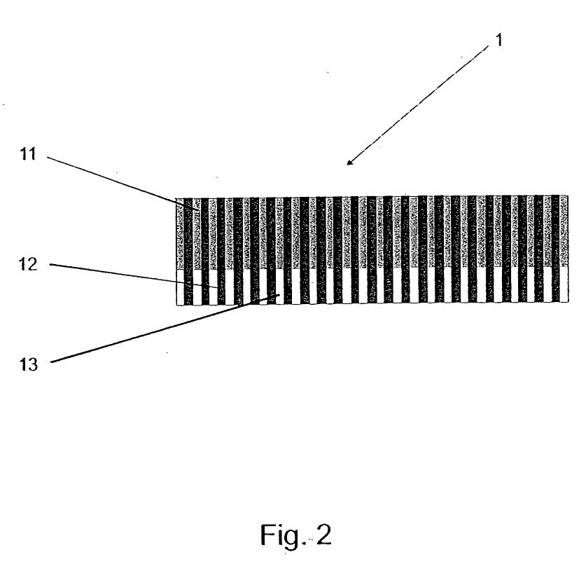

FIG. 2 shows the strip 1 of the adhesive tape of the invention according to FIG. 1 in a side section. On the underside of the backing 11 is an adhesive coating 13. Because of the hot-melt adhesive 13 the holes 12 have been made permanently right through the backing, with the aid of hot needles.

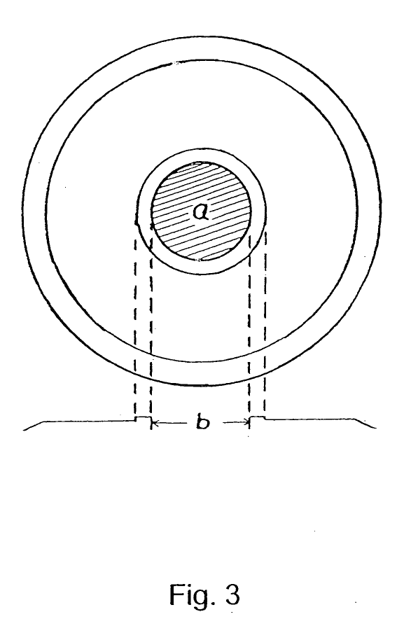

FIG. 3 shows a Gurley orifice plate having an open area “a” defined by a diameter “b.”

1. A method of venting a closed space which has a higher air pressure than a space surrounding said closed space, said method comprising adhering a single-sided self-adhesive tape across an aperture in said closed space, where:
the single-sided self-adhesive tape comprises a backing and a hotmelt adhesive applied to one side of said backing, and has an air permeability on the backing side of more than 30 cm³/(cm²*s), and
the adhesive tape is perforated, and the number of holes is at least 5/cm².

2. The method according to claim 1, wherein the adhesive tape is between 150 and 500 μm thick.

3. The method according to claim 2, wherein the adhesive tape is between 200 and 350 μm thick.

4. The method according to claim 1, wherein the adhesive tape has an air permeability on the backing side of more than 40 cm³/(cm²*s).

5. The method according to claim 4, wherein the adhesive tape has an air permeability on the backing side of more than 50 cm3/(cm²*s).

6. The method according to claim 1, wherein the adhesive tape exhibits a breaking elongation between 10% and 50%.

7. The method according to claim 1, wherein a nonwoven is used as backing material.
